(19) United States
(12) Patent Application Publication
(10) Pub. No.: US 2012/0318131 A1
(43) Pub. Date: Dec. 20, 2012

(54) POLYMER CERAMIC COMPOSITE

(75) Inventor: Mark Forrest, Geelong (Victoria) (AU)

(73) Assignee: VCAMM LIMITED, Geelong, Victoria (AU)

(21) Appl. No.: 13/388,822

(22) PCT Filed: Aug. 4, 2010
(86) PCT No.: PCT/AU10/00989

§ 371 Date: Sep. 7, 2012

(30) Foreign Application Priority Data
Aug. 4, 2009 (AU) 2009903624

(51) Int. Cl. C08L 77/10; C08L 63/00; C08K 3/40; B64D 7/00; F41H 5/08; F41H 7/00; B63G 13/00; B32B 27/18; F41H 5/02

(52) U.S. Cl. 89/36.02; 442/135; 523/400; 524/538; 523/445; 524/404; 524/443; 523/444; 523/440; 89/921; 89/930; 89/903

(57) ABSTRACT

There is provided a polymer ceramic composite which includes one or more particulate ceramics and a mixture of polymers. There is further provided methods of manufacture and application of the polymer ceramic composition. The composition finds use as a mouldable armour strike face, particularly in personal protective equipment and in vehicle or aircraft armour.

### FIELD OF INVENTION

The present invention relates to polymer ceramic composites and to methods of manufacturing said composites. The composites find use as strike faces for both body and vehicle armour.

### BACKGROUND

Armour systems, designed for use as personnel protection, have developed from natural fibres, through metals and ceramics, to composite systems as modern threat levels have increased from hand held weaponry to high powered ballistic systems. As the threat level increases, so does the efficacy of the armour system which must be designed to mitigate advances in offensive weapons technology. Previous noteworthy advances in armour include the use of aromatic polyamides (Aramids) such as Kevlar™, the development of strike faces to improve the performance of Kevlar™, and the development of ever stronger aromatic polyamide fibre systems. There is a current focus on improving the ceramic strike face systems to further increase ballistic resistance.

The use of monolithic ceramics as strike face media of armour has been very successful due to their relatively high compressive strengths and very high hardness. However, there are a number of shortcomings with their use in ballistic applications. A major drawback is the low tensile strength which reduces the effectiveness when interacting with projectile-induced shockwaves leading to premature failure. Secondly, the brittle nature of ceramics and their large impact fracture zone can result in extensive cracking which can influence multi-hit performance. The main drawback, however, is the mass associated with the strike face, given the high proportion of weight they carry within an armour package. The modern soldier will typically don up to 20 kg of protective gear, in addition to having to carry rations, survival equipment, water, ammunition and offensive weapons. Weight decreases in armour combined with improved performance allow the soldier to move more freely, carry more gear, and generally improve infantry survivability.

A further drawback is one of cost. Conventional ceramics are often processed for hours at elevated temperatures. Large torso sized ceramic plates are complex to manufacture and are subject to cracking in use.

Strike face media for use in armour applications are usually fixed to a backing, for example, an aromatic polyamide backing.

Ceramic filled polymer armour prepared by mixing polymer with ceramic aggregate has been disclosed [Sandstrom D., Los Alamos Science, Summer, 1989]. A polymer ceramic composite prepared by compression moulding a granular alumina ceramic having maximum particle size of 8 mm with a vinylester polymer resin has been disclosed [Arias A. et al, Composite Structures 61, 2003, 151].

It would be desirable to provide composites that may be fabricated into an armour strike face that are lightweight, easy to manufacture and advantageous with respect to ballistic impact.

### SUMMARY OF INVENTION

To this end, in one aspect of the invention there is provided a polymer ceramic composite including one or more particulate ceramics and a mixture of polymers at least one of which is an aromatic polyamide. The one or more particulate ceramics may be a carbide or nitride of Groups 13-15 of the Periodic Table. The mixture of polymers preferably includes a particulate epoxy or phenolic resin.

The aromatic polyamide is preferably in the form of a pulp or flock. By pulp or flock it is meant a highly fibrillated chopped fibre that enhances performance by providing excellent reinforcement. The length of the fibres is preferably in the range of between 0.1 to 1 mm.

The particulate ceramic is preferably present in an amount of between 20% and 90% by weight relative to the combined weight of particulate ceramic and polymers. The particulate ceramic is preferably of average particle size from between 100 nm and 5 mm, more preferably from between 1 micron and 1 mm, even more preferably from between 2 micron and 100 micron.

The composite of the present invention is advantageous over monolithic ceramics by using the strength of an aromatic amide/polymer matrix to suspend a ceramic powder aggregate. The short range tensile strength of the system is such that upon impact, the matrix provides enough support to the ceramic particulate to allow deformation of the incoming round to occur, along with impact shockwave attenuation and deceleration, leading to improved performance of the aromatic polyamide backing.

A further advantage of the invention is the reduction in weight which arises from the direct substitution of a higher density ceramic phase with the lower density polymer binder. Accordingly, for a given volume of material, the polymer ceramic composite will have a lower mass than traditional ceramic armour. In addition, polymer ceramics display extremely localised deformation behaviour during ballistic impact. This means they have an extremely improved multi-hit capability over that of traditional monolithic ceramics, which shatter upon impact.

In another aspect of the invention there is provided a polymer ceramic composite including one or more particulate ceramics having an average particle size of between 100 nm and 5 mm, preferably between 1 micron and 1 mm, more preferably between 2 micron and 100 micron, and one or more polymers. The one or more polymers are preferably selected from particulate phenolic or epoxy resins.

In another aspect of the invention there is provided a method of preparing a polymer ceramic composite including the steps of:

a) combining one or more particulate ceramics and a mixture of polymers, at least one of which is an aromatic polyamide; and

b) compression moulding the resulting mixture at elevated temperature and pressure.

Preferably, the resulting mixture is subjected to ball milling prior to compression moulding.

A further advantage of the composites of the present invention is that they do not necessarily require containment, for example, within a frame, such as a steel frame, in order to be effective.

A yet further advantage of the invention is the lower cost of manufacture and more complex geometry accessible using well established polymer processing techniques. Traditional ceramics take hours to form. The cycle time of the polymer ceramic systems disclosed herein are on the order of seven minutes, reducing both labour and energy costs per unit. Other advantages include the ability to form geometries that cannot be created via traditionally fired ceramics.

In a further aspect of the invention there is provided a use of any of the above mentioned polymeric ceramic compositions as a mouldable armour strike face. The armour strike face may be attached or fixed to a suitable backing material such as an aromatic polyamide.

The strike face may find use in personal protective equipment, in armour for land vehicles, watercraft or aircraft, and in further applications where protection from ballistic threat is required.

Accordingly, the invention provides lightweight, ballistically superior, mouldable armour strike faces for both body and vehicle armour applications, at a fraction of the cost and manufacturing time associated with traditional monolithic ceramic systems.

### DETAILED DESCRIPTION OF THE INVENTION

It will now be convenient to describe the invention with reference to particular embodiments and examples. These embodiments and examples are illustrative only and should not be construed as limiting upon the scope of the invention. It will be understood that variations upon the described invention as would be apparent to the skilled addressee are within the scope of the invention. Similarly, the present invention is capable of finding application in areas that are not explicitly recited in this document and the fact that some applications are not specifically described should not be considered as a limitation on the overall applicability of the invention.

The particulate ceramic for use in the composite of the present invention may be a carbide or nitride of Groups 13-15 of the Periodic Table of the Elements or mixtures thereof. Particularly preferred ceramics are boron carbide, boron nitride or silicon carbide or mixtures thereof. The particle size of the ceramic is not critical and may be in the range of 100 nm to 5 mm. Preferably, the particle size is in the range of 1 micron to 1 mm. The particle size range is not critical and ceramic particulates of broad or narrow particle size distributions may be utilised. The amount of ceramic relative to the total weight of the composite is preferably 20-90%, more preferably 40-85%.

Polymers for use in the polymer mixture may be phenolic or epoxy based resins or mixtures thereof. Preferably, the polymers are in particulate form. The particle size of the polymer is not critical and may be in the range of between 1 micron and 5 mm. The polymer may be present in an amount from between 5% to 50% by weight, relative to the total weight of the composite, preferably from between 10% and 30% by weight.

The polyamide is preferably in the form of a pulp or flock. The polyamide may be present from 0.1% to 10% by weight relative to the total weight of the polymer mixture. A preferred polyamide is Kevlar™.

The particulate ceramic and polymer mixture containing the polyamide are mixed prior to compression moulding. Preferably mixing is achieved by ball milling a mixture of particulate ceramic and polymer mixture containing the polyamide. The time of ball milling is not critical and typically times of the order of one hour yield acceptable results.

Strike faces may be prepared through moulding by traditional compression moulding techniques. Typically, the mixture is compression moulded at elevated temperature. Temperatures in excess of 100° C. are preferred. A particularly preferred temperature is 140° C. The compression pressure may vary widely. Tonnage pressures from between 5 and 200 ton may be utilised, preferably tonnage pressures from between 50 and 150 ton are utilised.

In a particularly preferred embodiment of the invention, boron carbide powder (mixed particle size), boron nitride powder (mixed particle size), epoxy resin powder or phenolic resin powder and Aramid (aromatic polymer) pulp may be compression moulded at 140° C. and 60 tons pressure to form a strike face.

In an alternate embodiment, the composite mixture may be compression moulded in the presence of a preform. A preferred preform is a glass fibre preform. More preferred is glass fibre woven preform.

In this embodiment, the mould cavity is lined with the glass preform and a charge of the powder mixture, preferably after being subjected to ball milling, is added followed by compression moulding to form a strike face. Preferably compression moulding is performed at 140° C. and 60 tons pressure.

The resulting armour systems may comprise a very high volume fraction of ceramic (boron carbide, boron nitride or silicone carbide or combinations thereof at around 50% by weight) aggregate, encased in a polymer matrix (phenolic or epoxy based), plus the inclusion of aromatic polyamide (Kevlar™) pulp or flock. Multiple prototypes have been built and tested both ballistically and mechanically. Armour equivalence has been tested against traditional monolithic silicone carbide tiles of an equivalent areal density (8 kg per meter squared of material) against fragment/shrapnel threats. Like monolithic silicon carbide, polymer ceramics have been shown to effectively deform the projectile. They have also been shown to maintain their ballistic limit during multiple impacts on a single tile, beyond the point at which monolithic ceramics like silicon carbide become ineffective.

Traditional armour systems consist of a strike face (used to slow and blunt the projectile) over a thick backing of aromatic polyamide cloth. The composite of the present invention replaces the traditional monolithic ceramic strike face and is bonded to aromatic polyamide cloth in a similar fashion as the heavier more expensive ceramic which they replace.

Furthermore, the polymer ceramics are formed at relatively low temperatures, and may rely on ceramic aggregate selection, and adhesive bond strength for increases in performance. This is likely due to their effect on incoming projectiles, which consists of deformation and deceleration, all of which increase the efficacy of the aromatic polyamide backing.

The following examples are intended to illustrate the scope of the invention and to enable reproduction and comparison. They are not intended to limit the scope of the disclosure in any way.

### EXAMPLES

### Ceramics and Polymers

Silicon carbide was obtained from Pacific Abrasives Pty. Ltd. Boron carbide was obtained from CMIC Heilongjiang Import and Export Co., Ltd. Cubic boron nitride was obtained form Hunan Sukan Ultra-hard material Co., Ltd. The ceramics all had a mean particle size of 5-10 micron.

Three ceramics were examined in the preparation of polymer composites, pure silicon carbide, pure boron carbide and a 1:1 by weight mixture of boron carbide and boron nitride.

The polymer used was a phenolic resin and was a general powder pressing grade obtained from Huntsman Chemical Company Australia Ltd. The polymer resin was added at a level of 15, 20 or 25% by weight. Where utilised, aromatic polymer pulp was added at a level of 1% by weight relative to the weight of polymer resin.

### Glass Preform

The glass fibre used in the system was a robust, 3D woven material incorporating a z yarn manufactured by 3TEX. Systems were examined having no glass preform, glass on the distal surface or glass on both surfaces.

### Sample Preparation

All samples were prepared to give a nominal areal density of 8 kg/m².

### Powder Preparation

Appropriate amounts of sample constituents were pre-weighed with mass loss during pressing taken into consideration. The weighed powder mixture was transferred to a one litre steel ball mill jar along with six, 8.7 mm diameter zirconia grinding media. These containers were then placed inside a single axis ball mill and rotated at 200 rpm for a period of one hour. For specimens containing aromatic polymer pulp, this was added in the last 10 minutes of the process to limit fibre damage.

### Pressing Methodology

Samples were pressed in a die cavity mould with two floating rectangular aluminium mould plates measuring 203×127×3 mm. Samples were placed within the cavity and wrapped with a release film to both ease de-moulding and limit mass loss from the sample during compression. The compression moulding cycle lasted seven minutes in total dispersed with four “breathe cycles” where all pressure was removed for a period of 10 seconds each. The moulding temperature used was 140° C. with the pressure level required for the particular trial (60, 80 or 100 ton).

### Mechanical Testing

Compressive Testing Compressive testing was executed on a screw-driven MTS test-frame fitted with a 100 kN load cell with an accuracy of ±0.4% in the range tested. Specimens measuring 30×30 mm were waterjet-cut from a retained portion of plate moulding (the other portion being used for ballistic evaluation). A minimum of six specimens per sample (16 samples in total) were assessed. The specimen was placed upon a polished lower platen and compressed by a hardened 10.0 mm diameter steel dowel pin held within a mounting fixture. The sample was tested at a crosshead speed of 1 mm/min.

### Flexural Testing

Specimens measuring 105×9 mm were waterjet-cut from a retained portion of plate moulding. A minimum of six specimens per sample (16 samples in total) were assessed. Testing was performed on a screw-driven MTS test-frame fitted with a 100 kN load cell with an accuracy of ±0.4% in the range tested. The flexure test was carried out in accordance with the ASTM C1341-00 Standard Test Method for Flexural Properties of Continuous Fibre-Reinforced Advanced Ceramic Composites. The support span used was 96 mm with a crosshead rate 2 mm/min.

### Ballistic Testing

Each polymer ceramic coupon (˜100 mm square) was bonded to a standard 10-ply aramid reinforced thermoplastic measuring 200 mm square using a Hysol 9309 adhesive under a pressure of about 1 bar. When ballistically tested, each target was fixed to two horizontal bars using corner clamps.

Fragment Simulating Projectile (FSP) was used as the threat with strike velocities varied by standard charge-adjustment practices. The round was a 1.1 g, 0.22″ calibre in low alloy steel with a Rockwell C value of 27±3. The geometry was a chisel nose.

The points of strike (POS) were at least 40 mm from an edge and/or a previous POS. After each impact the round was recovered and its diameter measured. The bulge height at the rear of the target was also measured. The observed velocities were corrected to strike velocities and duly noted for each round. In the case of those specimens containing one layer of glass reinforcement, the strike face used was the non-reinforced side. The deformation of the particle was quantified by measuring the maximum diameter of the round after impact.

### Results

All plates produced appeared well formed with a highly homogeneous nature. In the samples employing a glass preform, resin distribution appeared good and bonding to the matrix resin was high. The plates produced had an areal density of 8±0.4 kgm⁻². After the composite ceramics were manufactured, standard Kevlar™ backings were bonded, giving an average areal density of all specimens of 12.4±0.4 kgm⁻².

### Ballistic Response

Ballistic tests for 16 trials of ceramic/resin samples were carried out and the results are summarised in Table 1. V50 defines the velocity at which 50% of the projectiles penetrate the sample and 50% do not. The results ranged from between 545 and 835 ms⁻¹.

TABLE 1

| | | Polymer | Pulp | Glass | P | ρ | V50 | | | |
|---|---|---|---|---|---|---|---|---|---|---|
| Trial | Ceramic | wt. % | wt. % | preform | (ton) | (kgm⁻³) | (ms⁻¹) | V50/ρ | CB | FSP |
| 1 | SiC | 15 | 0 | None | 60 | 1926 | 580 | 0.301 | R, C | 5.70 |
| 2 | SiC | 20 | 0 | Single | 80 | 2080 | 660 | 0.317 | C | 5.78 |
| 3 | SiC | 25 | 1 | Double | 100 | 1880 | 735 | 0.391 | NV | 6.88 |
| 4 | SiC | 15 | 1 | None | 60 | 1876 | 545 | 0.291 | R, C | 5.77 |
| 5 | B4C | 15 | 0 | None | 100 | 1481 | 545 | 0.368 | C | 5.56 |
| 6 | B4C | 20 | 0 | Double | 60 | 1607 | 705 | 0.439 | NV | 6.14 |
| 7 | B4C | 25 | 1 | Single | 60 | 1686 | 835 | 0.495 | NV | 7.20 |
| 8 | B4C | 15 | 1 | None | 80 | 1648 | 610 | 0.370 | R, C | 5.57 |
| 9 | B4C/BN | 15 | 1 | Single | 60 | 1760 | 700 | 0.398 | R, C | 6.18 |
| 10 | B4C/BN | 20 | 1 | None | 100 | 1885 | 680 | 0.361 | R, C | 6.11 |
| 11 | B4C/BN | 25 | 0 | None | 80 | 1993 | 780 | 0.391 | R, C | 7.20 |
| 12 | B4C/BN | 15 | 0 | Double | 60 | 1726 | 750 | 0.435 | NV | 6.51 |
| 13 | SiC | 15 | 1 | Double | 80 | 1797 | 690 | 0.384 | NV | 6.26 |
| 14 | SiC | 20 | 1 | None | 60 | 1992 | 775 | 0.389 | C | NR |
| 15 | SiC | 25 | 0 | None | 60 | 2192 | 660 | 0.301 | C | 6.90 |
| 16 | SiC | 15 | 0 | Single | 100 | 1867 | 650 | 0.348 | R, C | 6.07 |

P: forming pressure;
CB: cracking behaviour wherein R = radial cracking, C = circumferential cracking and NV = cracking not visible;
FSP: FSP deformed maximum diameter at V-50

1. A polymer ceramic composite including one or more particulate ceramics and a mixture of polymers, at least one of which is an aromatic polyamide.

2. The composite of claim 1 wherein the one or more particulate ceramics is a carbide or nitride of Groups 13-15 of the Periodic Table of the Elements.

3. The composite of claim 1 or claim 2 wherein the one or more particulate ceramics is selected from the group consisting of silicon carbide, boron carbide, boron nitride or mixtures thereof.

4. The composite of any one of claims 1 to 3 wherein the mixture of polymers includes a particulate epoxy or phenolic resin.

5. The composite of any one of claims 1 to 4 wherein the aromatic polyamide is in the form of a pulp or flock.

6. The composite of any one of claims 1 to 5 wherein the particulate ceramic is present in an amount of between 20% and 90% by weight relative to the combined weight of particulate ceramic and polymers.

7. The composite of any one of claims 1 to 6 wherein the one or more particulate ceramics has an average particle size of between 100 nm and 5 mm.

8. The composite of any one of claims 1 to 7 wherein the one or more particulate ceramics has an average particle size of between 1 micron and 1 mm.

9. The composite of any one of claims 1 to 8 further including a glass fibre, three-dimensional woven preform.

10. A polymer ceramic composite including one or more particulate ceramics having an average particle size of between 100 nm and 5 mm and one or more polymers.

11. The composite of claim 10 wherein the one or more polymers includes a particulate epoxy or phenolic resin.

12. A method of preparing a polymer ceramic composite including the steps of:
a) combining one or more particulate ceramics and a mixture of polymers, at least one of which is an aromatic polyamide; and
b) compression moulding the resulting mixture at elevated temperature and pressure.

13. The method of claim 12 wherein the said resulting mixture is ball milled prior to compression moulding.

14. The method of any one of claim 12 or 13 wherein the temperature is greater than 100° C.

15. The method of any one of claims 12 to 14 wherein the compression pressure is greater than 5 tons.

16. The method of any one of claims 12 to 15 wherein in step b) the compression moulding is performed in the presence of a glass fibre, three-dimensional woven preform.

17. Use of a polymer ceramic composite according to any one of claims 1 to 11 as an armour strike face.

18. An armour strike face including a polymer ceramic composite according to any one of claims 1 to 11.

19. Use of an armour strike face according to claim 18 in personal protective equipment or in the protection of land vehicles, watercraft or aircraft.
